(19) United States
(12) Patent Application Publication
(10) Pub. No.: US 2023/0186152 A1
(43) Pub. Date: Jun. 15, 2023

(54) ITERATIVE DATA-DRIVEN CONFIGURATION OF OPTIMIZATION METHODS AND SYSTEMS

(71) Applicant: Kinaxis Inc., Ottawa (CA)

(72) Inventors: Sebastien OUELLET, Ottawa (CA); Masoud CHITSAZ, Ottawa (CA); Jacob LAFRAMBOISE, Ottawa (CA)

(21) Appl. No.: 17/674,410

(22) Filed: Feb. 17, 2022

Related U.S. Application Data
(60) Provisional application No. 63/287,684, filed on Dec. 9, 2021.

(51) Int. Cl. G06N 20/00

(52) U.S. Cl. CPC G06N 20/00

(57) ABSTRACT

Systems and methods that extract features from a set of optimization problems, and compile performance characteristics of optimization algorithms that are applied to each optimization problem. Machine learning models are trained on a first portion of a dataset that comprises the features and performance characteristics. A model is selected based on performance on a second portion of the dataset. The selected model is applied to features of a new optimization problem to provide performance characteristics of each optimization algorithm, which can then be ranked based on the respective performance characteristics. Either the first-ranked optimization algorithm can be applied to the new optimization problem, or successively-ranked optimization algorithms can be executive iteratively.

### CROSS-REFERENCE TO RELATED APPLICATIONS

The present application claims the benefit of priority of U.S. Ser. No. 63/287,684 filed on Dec. 9, 2021, the content of which is incorporated herein by reference.

### BACKGROUND

Optimization problems differ in the types of variables, constraints, and other related matters that determine the overall configuration of the entity to be optimized. The conventional approach has been to apply one algorithm to these myriad of optimization problems, which often provides unsatisfactory results. One approach to mitigate this issue is the creation of a portfolio of optimization algorithms. Each optimization algorithm in the portfolio is executed on a given optimization problem, and the best result is selected after executing the entire portfolio of optimization algorithms on the given optimization problem. However, this approach can become complex, as each optimization algorithm can have multiple options that can be adjusted or selected, leading to multiple “versions” of each algorithm in the portfolio. It becomes expensive and time consuming to try many optimization algorithms (along with different associated multiple options), in order to find which optimization algorithm solves the problem in the best manner.

Usually, one has to apply all of the optimization algorithms on the problem at hand, and once all of the different solutions are obtained (that is, one from each algorithm), the solution which provides the best metrics is then selected. However, each optimization algorithm takes a different amount of time to execute. Furthermore, there are limits placed on the computational infrastructure (for example, the server, the central processing unit, etc.) by having to solve many optimization problems in real time.

For example, in the field of supply chain management, supply chain optimization problems are complex; the complexity depends on many features, such as the number of suppliers, the number of parts and products to be transported, the number of production facilities, among many other features. Each optimization algorithm takes a different amount of time to execute on a given supply chain problem. For example, an optimization algorithm may take hours or days to run. Furthermore, each optimization algorithm returns a different solution (that is, solutions with differing quality or accuracy) for the supply chain optimization problem. In addition, the portfolio of optimization algorithms is executed on each complex supply chain, thereby increasing the amount of computational infrastructure required, in terms of data storage, CPU time, and so forth.

Therefore, there is a need to identify which optimization algorithm (from a portfolio of optimization algorithms) should be applied to a given problem, without necessarily executing an entire portfolio of optimization algorithms.

### BRIEF SUMMARY

Disclosed herein are machine learning systems and methods that select an appropriate optimization algorithm in real-time. Training of machine learning models is based on features of the optimization problem. These features may include the number of variables, the number of constraints, structures, relationships between variables, and so on.

Disclosed herein are systems and methods that, where it is possible to calculate a solution using many different options, the disclosed systems and systems use machine learning for providing optimum options for a solution, such that the optimum solution meets accuracy and processing speed criteria. The machine learning model learns from previous optimization solutions and suggests the best options, so that a new solution is calculated as fast as desired, and with the best quality metrics as desired. This is important, since increasing the quality of the solution often takes a lot of processing time.

For example, in the field of supply chain management, different supply and operations planning (S&OP) problems have different levels of complexity of associated optimization models. In different situations, a user may need a different level of solution accuracy for the S&OP problem at hand. The disclosed systems and methods select a correct solution method for the right S&OP problem—that is, optimize supply chain planning for a family of products. The selection mechanism can be trained based on results obtained by applying different methods to similar problems. In some embodiments, the training can be done offline so that the trained model will not incur any extra delay in returning the solution to the user.

The disclosed methods and systems allow for the flexibility of not only choosing different optimization algorithms, but also, different configurations within a given optimization algorithm. The disclosed methods and systems also increase computer efficiency by cutting down on the CPU time needed to optimize a problem, since only one optimization algorithm is selected from an entire portfolio of algorithms, for execution on a complex optimization problem. The selection of the optimization algorithm is based on the algorithm providing the best metrics. Finally, the disclosed methods and systems require less computer storage. All in all, knowledge of which optimization algorithm returns the best solution (in a given time frame) is valuable in terms of saving computing power and user waiting time.

Once an optimization algorithm is selected and executed, the result is a supply chain plan that moves resources and goods, and schedules manufacturing.

The disclosed methods and systems improve computer efficiency, CPU time and data storage. For example, computer efficiency is enhanced, in that the disclosed systems and methods provide an optimization solution in less time: namely one optimization algorithm is applied to an optimization problem in order to arrive at the best solution possible (in terms of a combination of run-time and quality metric), instead of applying all available algorithms to the given problem. Furthermore, since the “CPU time” is the total time that computer spends to optimize a problem by an optimization algorithm, the disclosed systems and methods decrease CPU time since not all of the optimization algorithms are executed on the problem at hand. Finally, there is improvement in data storage, since one optimization algorithm is selected to apply on a given optimization problem, thereby reducing the number of optimized solutions kept in storage.

In one aspect, a computer-implemented method includes extracting, by a processor, a first set of features from a plurality of optimization problems, receiving, by the processor, respective characteristics of a plurality of optimization algorithms, the characteristics of each algorithm based on application of the optimization algorithm applied to each optimization problem of the plurality of optimization problems, training, by the processor, a plurality of machine learning models on a first portion of a dataset, the dataset includes the first set of features and the respective characteristics, selecting a trained machine learning model based on a second portion of the dataset, extracting, by the processor, a second set of features related to a new optimization problem, and obtaining, by the processor, predicted performance characteristics for each optimization algorithm based on application of the selected trained machine learning model on the second set of features.

The performance characteristics may comprise a run-time and a performance metric. Furthermore, each of the first set of features and the second set of features can be based on tabular data and graph structures generated from the tabular data. In addition, the performance characteristics can comprise a run-time and a performance metric.

The computer-implemented method may also include ranking, by the processor, each optimization algorithm according to the predicted performance characteristics. A first-ranked optimization algorithm may be executed on the new optimization problem. Alternatively, successively-ranked optimization algorithms can be executed iteratively until one or more conditions are satisfied. The one or more conditions can be: obtaining an actual run-time and an actual performance metric that is acceptable; or attaining a run-time limit; or expecting no further improvement on the run-time and performance metric of the successively-ranked optimization algorithms.

Other technical features may be readily apparent to one skilled in the art from the following figures, descriptions, and claims.

In another aspect, a system includes a processor. The system also includes a memory storing instructions that, when executed by the processor, configure the system to extract, by a processor, a first set of features from a plurality of optimization problems, receive, by the processor, respective characteristics of a plurality of optimization algorithms, the characteristics of each algorithm based on application of the optimization algorithm applied to each optimization problem of the plurality of optimization problems, train, by the processor, a plurality of machine learning models on a first portion of a dataset, the dataset includes the first set of features and the respective characteristics, select a trained machine learning model based on a second portion of the dataset, extract, by the processor, a second set of features related to a new optimization problem, and obtain, by the processor, predicted performance characteristics for each optimization algorithm based on application of the selected trained machine learning model on the second set of features.

The performance characteristics may comprise a run-time and a performance metric. Furthermore, each of the first set of features and the second set of features can be based on tabular data and graph structures generated from the tabular data. In addition, the performance characteristics can comprise a run-time and a performance metric.

The system may also include instructions that further configure the system to rank, by the processor, each optimization algorithm according to the predicted performance characteristics. A first-ranked optimization algorithm may be executed on the new optimization problem. Alternatively, successively-ranked optimization algorithms can be executed iteratively until one or more conditions are satisfied. The one or more conditions can be: obtaining an actual run-time and an actual performance metric that is acceptable; or attaining a run-time limit; or expecting no further improvement on the run-time and performance metric of the successively-ranked optimization algorithms.

Other technical features may be readily apparent to one skilled in the art from the following figures, descriptions, and claims.

In yet another aspect, a non-transitory computer-readable storage medium, the computer-readable storage medium including instructions that when executed by a computer, cause the computer to extract, by a processor, a first set of features from a plurality of optimization problems, receive, by the processor, respective characteristics of a plurality of optimization algorithms, the characteristics of each algorithm based on application of the optimization algorithm applied to each optimization problem of the plurality of optimization problems, train, by the processor, a plurality of machine learning models on a first portion of a dataset, the dataset includes the first set of features and the respective characteristics, select a trained machine learning model based on a second portion of the dataset, extract, by the processor, a second set of features related to a new optimization problem, and obtain, by the processor, predicted performance characteristics for each optimization algorithm based on application of the selected trained machine learning model on the second set of features.

The performance characteristics may comprise a run-time and a performance metric. Furthermore, each of the first set of features and the second set of features can be based on tabular data and graph structures generated from the tabular data. In addition, the performance characteristics can comprise a run-time and a performance metric.

The computer-readable storage medium may also include instructions that further configure the computer to rank, by the processor, each optimization algorithm according to the predicted performance metric and predicted run-time. A first-ranked optimization algorithm may be executed on the new optimization problem. Alternatively, successively-ranked optimization algorithms can be executed iteratively until one or more conditions are satisfied. The one or more conditions can be: obtaining an actual run-time and an actual performance metric that is acceptable; or attaining a run-time limit; or expecting no further improvement on the run-time and performance metric of the successively-ranked optimization algorithms.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Like reference numbers and designations in the various drawings indicate like elements.

FIG. 1 illustrates a block diagram in accordance with one embodiment.

FIG. 2 illustrates a block diagram of the training phase block shown in FIG. 1 in accordance with one embodiment.

FIG. 3 illustrates an example of a graph in accordance with one embodiment.

FIG. 4 illustrates a block diagram of the compute features block shown in FIG. 1 in accordance with one embodiment.

FIG. 5 illustrates a block diagram of the machine learning output block shown in FIG. 1 in accordance with one embodiment.

FIG. 6 illustrates a block diagram of the predicted performance characteristics block shown in FIG. 1 in accordance with one embodiment.

FIG. 7 illustrates a block diagram of the performance optimization block shown in FIG. 1 in accordance with one embodiment.

FIG. 8 illustrates of conditions in the decision block shown in FIG. 7 in accordance with one embodiment.

FIG. 9 illustrates a block diagram in accordance with one embodiment.

FIG. 10 illustrates a block diagram of the training phase block shown in FIG. 9 in accordance with one embodiment.

FIG. 11 illustrates a computer system in accordance with one embodiment.

FIG. 12 illustrates a block diagram in accordance with one embodiment.

### DETAILED DESCRIPTION

Methods and systems disclosed herein can comprise: an optimization solving framework comprising a set of optimizing algorithms used for solving an optimization problem; data representing each optimization problem to solve; data representing the quality of the optimized solution provided by each optimization algorithm for each optimization problem; data representing the run-time required to obtained the optimized solutions provided by each optimization algorithm for each optimization problem; and a machine learning framework.

Methods and systems disclosed herein can comprise the following steps:

1. Collection of data from each optimization problem that is solved, which provides input data for training one or more machine learning models. Each optimization problem is represented as a combination of graphical features and domain-specific features, each of which is machine-readable by a machine learning model. This assumes many similar problems are to be solved independently.

2. Each problem can be optimized by applying every optimization algorithm to the problem. Alternatively, successive problems can be optimized through a pretrained machine learning model. For example, if there are five hundred similar problems to solve, the first one hundred can be solved by each optimization algorithm in a portfolio of optimization algorithms. The graphical and tabular features of each of the first one hundred optimization problems, along with the run-time and quality of the solutions provided by each optimization algorithm, can be used to train the machine learning model. The remaining four hundred similar problems can then be solved using the trained machine-learning model.

3. Accumulation of data regarding the computation time taken by each optimization algorithm on a given problem, along with the quality of the optimized solution found.

4. Training a machine learning model to predict both the solution quality and the run-time of an optimization algorithm for a new optimization problem (this can become the aforementioned pretrained model at this point for following problems).

5. Iterate across the predicted run-times and solution quality to find an optimization algorithm amenable to the user—namely, solving the optimization problem within a reasonable amount of time and providing an acceptable solution.

The methods and systems can solve the problem stated above, as the problems can change over time. However, the machine learning model can generalize which optimization algorithms provide the best run-time and solution quality, given the characteristics (or features) of an optimization problem. This reduces the processing time and data storage needed to find an appropriate optimization algorithm for a current set of problems, thereby providing insights to a user about what makes a problem difficult to solve, while improving the quality of the solutions found.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Any combination of one or more computer readable storage media may be utilized. A computer readable storage medium may be, for example, but not limited to, an electronic, magnetic, optical, electromagnetic, infrared, or semiconductor system, system, or device, or any suitable combination of the foregoing.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing system memory devices, or any suitable combination of the foregoing, but would not include propagating signals. In the context of this document, a computer readable storage medium may be any tangible medium that can contain, or store a program for use by or in connection with an instruction execution system, system, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing system to produce a machine, such that the instructions, which execute via the processor of the computer or other programmable data processing system, create means for implementing the functions/acts specified in the schematic flowchart diagrams and/or schematic block diagrams block or blocks.

These computer program instructions may also be stored in a computer readable storage medium that can direct a computer, other programmable data processing system, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing system, or other devices to cause a series of operational steps to be performed on the computer, other programmable system or other devices to produce a computer implemented process such that the instructions which execute on the computer or other programmable system provide processes for implementing the functions/acts specified in the flowchart and/or block diagram block or blocks.

The schematic flowchart diagrams and/or schematic block diagrams in the Figures illustrate the architecture, functionality, and operation of possible implementations of systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and system can also be implemented as, special purpose logic circuitry, e.g., an FPGA (field programmable gate array) or an ASIC (application specific integrated circuit). For example, the processes and logic flows can be performed by, and systems can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

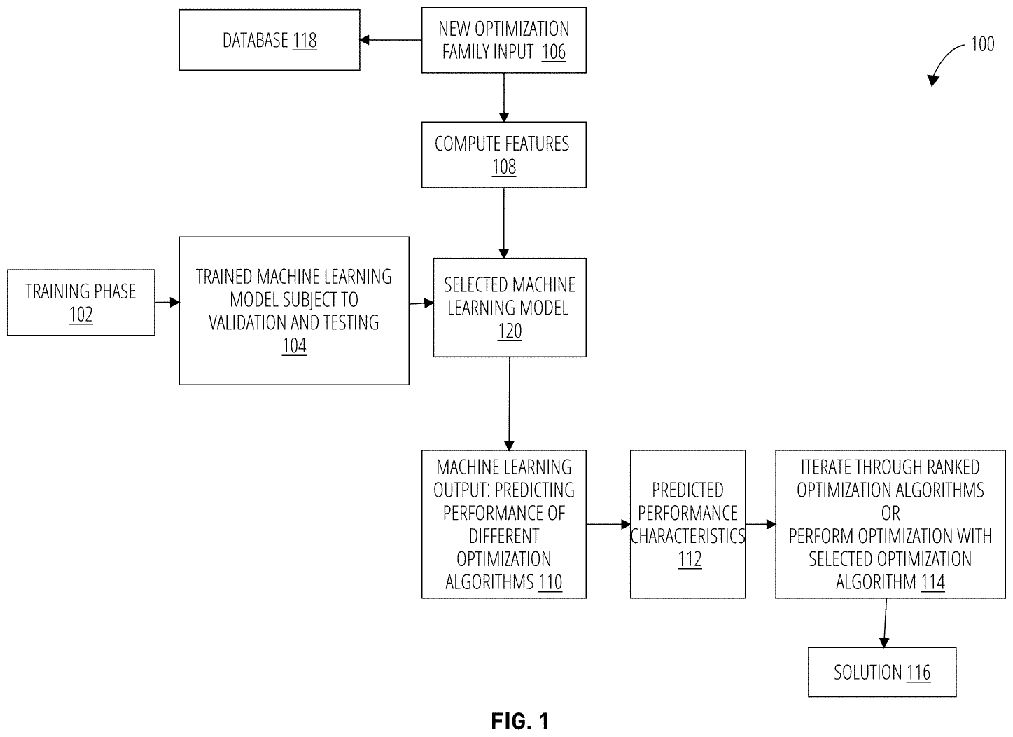

FIG. 1 illustrates a block diagram 100 in accordance with one embodiment.

In FIG. 1, a number of optimization families (or optimization problems) have already been solved, in that a number of optimization algorithms have been executed on each optimization family to find an optimal solution for each optimization family. The optimization algorithms may be versions of mixed-integer linear optimization.

For a given optimization family, each optimization algorithm takes a certain amount of run-time to execute. Furthermore, each optimization algorithm provides an optimized solution whose quality is measured by a corresponding quality metric. All of this information is stored in database 118. The term “optimization family” is used to include instances where it is not just one particular problem that is being optimized, but an entire family of related problems that is being optimized. As an example, with reference to supply chain management, an optimization family refers to a whole family of inter-dependent parts (in a supply chain) that have one or more relationships between each other.

In FIG. 1, a new optimization family (or “new problem”), shown at 106, is to be optimized. However, instead of executing each optimization algorithm on the new problem in order to find out which optimization algorithm provides the optimum solution, block diagram 100 illustrates the use of machine learning to predict how long each optimization algorithm will take to optimize the new problem, along with predicting the corresponding quality metric of each optimization algorithm. This approach greatly improves computer efficiency, CPU time and data storage, in that the laborious execution of each optimization algorithm on the new optimization problem is avoided.

For example, computer efficiency is enhanced, in that the disclosed systems and methods provide more in less time: namely one optimization algorithm is applied to an optimization problem in order to arrive at the best solution possible (in terms of a combination of run-time and quality metric), instead of applying all available algorithms to the given problem. Furthermore, since the “CPU time” is the total time that computer spends to optimize a problem by an optimization algorithm, the disclosed systems and methods decrease CPU time since not all of the optimization algorithms are executed on the problem at hand. Finally, there is improvement in data storage, since one optimization algorithm is selected to apply on a given optimization problem, thereby reducing the number of optimized solutions kept in storage.

Data associated with the new optimization family (item 106) can be stored in database 118. As an example, with reference to supply chain management, such data can include the lead time of a part, which sites are manufacturing this part, what are the components assembled for this part, and so on. Furthermore, the new optimization family input may be used to compute features of the new optimization family at 108. These features can be used in conjunction with a trained machine learning model to predict characteristics of each optimization algorithm (namely, predicted run-time and solution quality), as if it had been executed on the new optimization family.

The features computed at 108 can use the optimization family input (item 106) as input and data from the database 118. The optimization family input (item 106) may also be stored in the database 118, for possible later use in further training of machine learning models.

A training phase 102 can provide trained machine learning models at 104. The machine learning models may belong to a common class, or type, of model, or can be a mixture of different types of machine learning models. As an example, the machine learning models trained at training phase 102 can be any type of machine learning model. Non-limiting examples of machine learning models include decision trees, neural networks and support vector machines. In some embodiments, a tree-based machine learning model is used.

The machine learning models can be trained using hyperparameter optimization. Optimal hyperparameter values can be found by making use of different samples such as Bayesian, random, evolutionary and grid search algorithms.

Selection of the best machine learning model may be based on three portions of the data: a first portion for training each of the machine learning models; a second portion for validating the machine learning models, in which one machine learning model is selected, and a third portion to further test the selected machine learning model. With regards to the validation portion, a predicted output of each trained machine learning model is compared to the actual data in the validation portion. The machine learning model that provides the most accurate prediction is selected for the testing phase, in which the performance of the selected model can be tested one more time. In some embodiments, the data can be portioned as follows: 35% train, 35% validation, and 30% test. Other partitioning of the training data is also possible. The result of 104 is the selection of one trained machine learning model at 120, which can then be used to predict the performance of the different optimization algorithms at 110.

At 110, the selected trained machine learning model can predict the performance of each of the optimization algorithms, using the features that have been computed at 108.

Once the performance of each of the optimization algorithms is predicted via machine learning at block 110, the predicted performance characteristics are listed at 112, and may be ranked according to a pre-determined criteria. In some embodiments, the performance characteristics can include the run-time for executing the a given optimization algorithm, and metrics associated with one or more goals of the final optimization. As an example of the latter in the field of supply chain management, such metrics can include the timely availability of supplies, the cost of production, the overall revenue, and so on. In some embodiments, each metric can be weighted, with the total weighted sum providing an overall “quality” metric.

The top-ranked optimization algorithm can then be selected, and executed to perform the optimization on the optimization family at block 114, thereby providing an optimized solution at block 116. Alternatively, there can be an iteration of the ranked optimization algorithms until a reasonable solution is found.

The actual solution is then stored in the database 118, along with the characteristics associated with the selected optimization algorithm, for use in further machine learning training. In this manner, computer efficiency is increased, CPU time is decreased, and database storage is decreased by running only one optimization algorithm on the new optimization family.

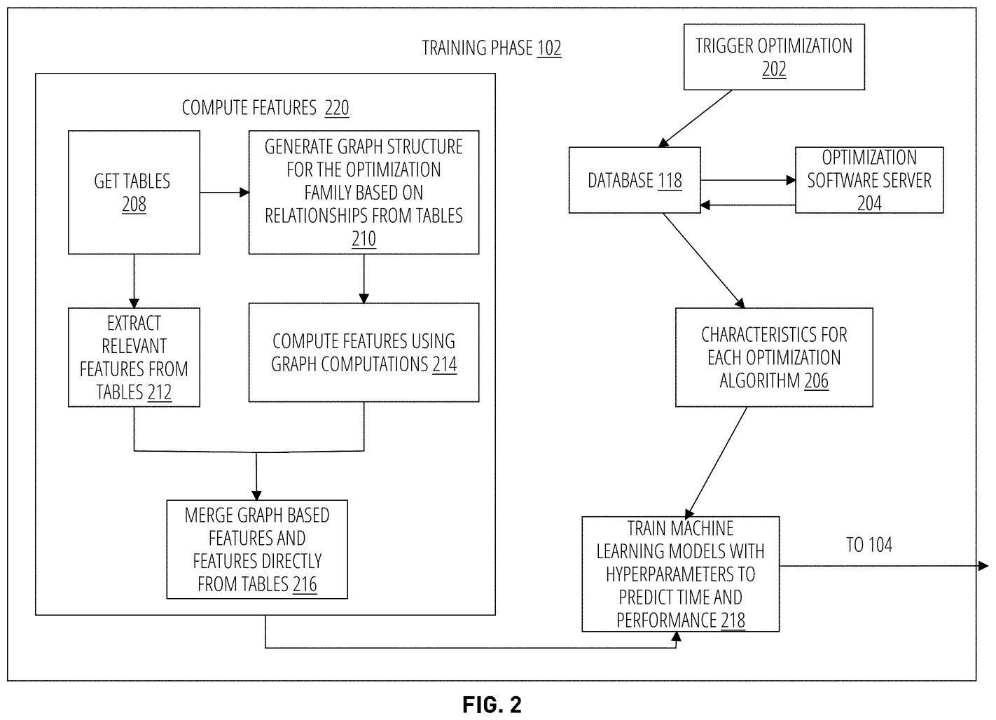

FIG. 2 illustrates a block diagram of the training phase 102 shown in FIG. 1, in accordance with one embodiment.

Features of each previous optimization families are computed at block 220. In some embodiments, features can be computed from basic input tabular data, and graphs (or tree structures) that are generated from the tabular input. Generation of graphical relationships from tabular data can provide additional knowledge of the structural relationship between various entities, thereby enhancing the robustness of the machine learning training. For example, in supply chain management of bicycles, table records provide useful data such as the names of the manufacturing sites, the amount of labor available per day at a production line, and so on, while graphs can be generated based on information in the tables, such as the relationship between the various components needed to manufacture a bicycle.

Basic input used to calculate features can include tables, at block 208. As an example, in the field of supply chain management, these tables can include a table of Bill of Materials, and other supply chain features. Relevant features may be extracted from the tables at block 212.

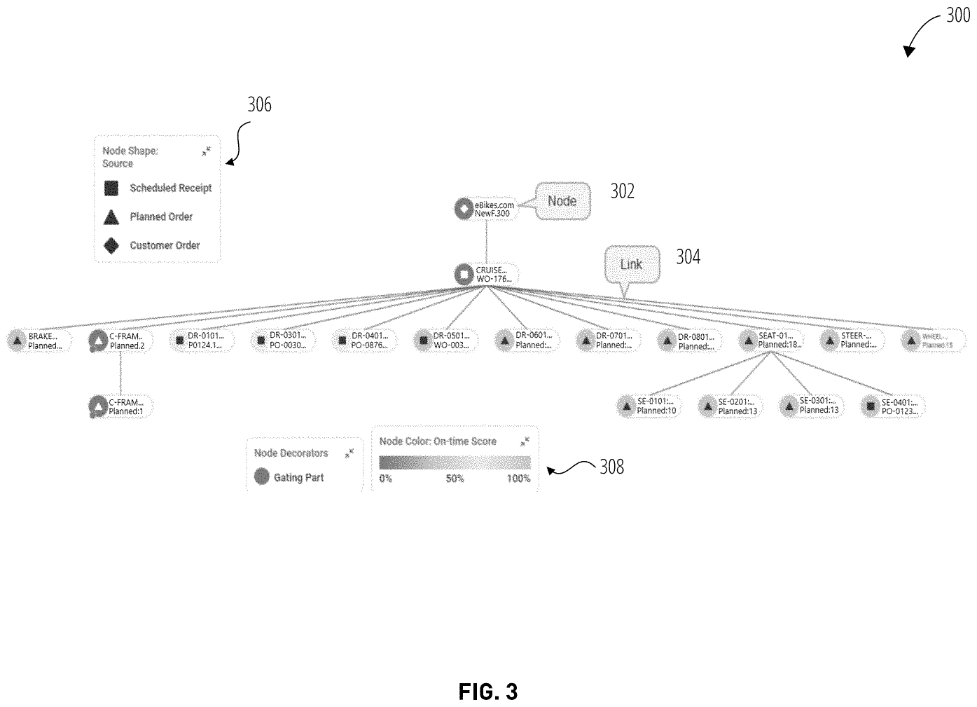

The tables (at block 208) can also be used to generate, at block 210, a graph structure for an optimization family based on relationships between entities in the tables. Data may be naturally understood as a network/graph and the relationships between the various data points matter for the problem at hand. For example, in the supply chain management of bicycles, one component of a bicycle is a wheel, which in turn requires an ‘X’ number of bearings. A graph of the data reveals that the bicycle requires an ‘X’ number of bearings. Furthermore, the relationships between the various data points are illustrated through a graph. For example, a bicycle with three layers of dependent materials is easier to plan for than a bicycle with seven layers. An example of a graph structure is shown in FIG. 3. Features of the graph structure are then computed using graph computations at block 214.

At block 216, the features extracted from the tables (at block 212) may be merged with the features computed at block 214.

At block 202, optimization can be triggered for the optimization family for which the features are being computed. This optimization results in a database 118 working in tandem with an optimization software server 204 to execute each optimization algorithm on the optimization family. In addition to providing the solution to the optimization problem, each optimization algorithm can also provide a set of characteristics associated with its execution. For example, characteristics can include the execution time of the optimization algorithm (on the given optimization family), along with different metrics that measure the quality of the optimized solution. As an example of the latter in the field of supply chain management, such metrics can include the timely availability of supplies, the cost of production, the overall revenue, and so on. In some embodiments, each metric can be weighted, with the total weighted sum providing an overall “quality” metric.

The characteristics from block 206 can be used with the merged features from block 216, to train machine learning models at block 218 in order to predict the characteristics of the optimization algorithms for new optimization families. In simple terms, the input for the training can include features of each optimization family and a feature that identifies a particular optimization algorithm (for example, an optimization algorithm identification number). The output labels can include the corresponding optimization algorithm characteristics.

The machine learning models can belong to a common class, or type, of model. As an example, machine learning models from a gradient boosting library can be used, such as LGBM. As a further example, the machine learning models trained at training phase 102 can be tree-based machine learning models. Other types of models are also possible, such as neural networks and support vector machines. The machine learning models can be trained using hyperparameter optimization. Optimal hyperparameter values can be found by making use of different samples such as Bayesian, random, evolutionary and grid search algorithms. In some embodiments, three to seven distinct machine learning models can be used. For each distinct machine learning model, it is possible to have a set of parameters associated with the distinct model. As such, one distinct machine learning model may actually result in multiple machine learning models as different parameter values are chosen. For example, if a machine learning model has a parameter than can have binary values, then the machine learning model can be run as two associated machine learning models.

FIG. 3 illustrates an example of a graph 300 in accordance with one embodiment, that can be generated in block 210 of FIG. 2.

The graph 300 illustrates relationships between different parts of a supply chain for the production of electronic bicycles. Each entity (or part) is identified as a node 302, while relationships between the entities are illustrated with links 304. In FIG. 2, the node shape key 306 describes the nature of the ordered entity, while the node colour key 308 reflects how often the order for each entity is on-time. This example graph is generated from a table of data for an optimization family.

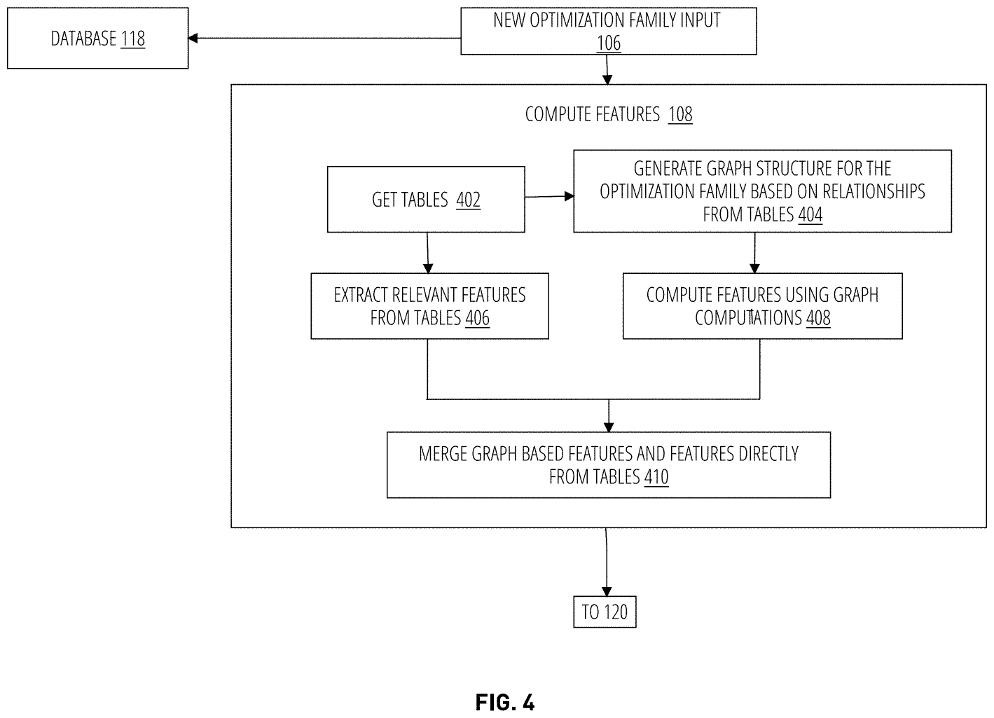

FIG. 4 illustrates a block diagram of the compute features block 108 shown in FIG. 1 in accordance with one embodiment.

The features of the new optimization family are computed in the same manner as in block 220 of FIG. 2.

Basic input used to calculate features can include tables, at block 402. As an example, in the field of supply chain management, these tables can include a table of Bill of Materials, and other supply chain features. Relevant features may be extracted from the tables at block 406.

The tables (at block 402) can also be used to generate, at block 404, a graph structure for an optimization family based on relationships between entities in the tables. Data may be naturally understood as a network/graph and the relationships between the various data points matter for the problem at hand. For example, in the supply chain management of bicycles, one component of a bicycle is a wheel, which in turn requires an ‘X’ number of bearings. A graph of the data reveals that the bicycle requires an ‘X’ number of bearings. Furthermore, the relationships between the various data points can be illustrated through a graph. For example, a bicycle with three layers of dependent materials is easier to plan for than a bicycle with seven layers. Features of the graph structure are then computed using graph computations at block 408.

At block 410, the features extracted from the tables (at block 406) may be merged with the features computed at block 408. The merged features may then be used by the trained machine learning model at 120 of FIG. 1.

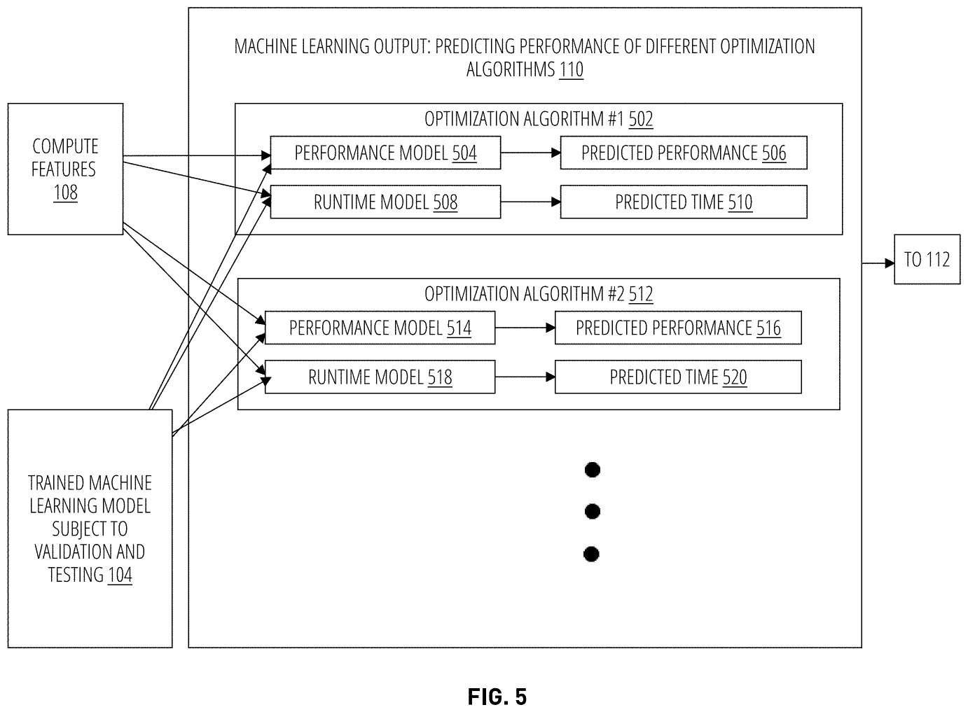

FIG. 5 illustrates a block diagram of the machine learning output block 110 shown in FIG. 1 in accordance with one embodiment.

The merged features of the new optimization family, which are computed at block 408, can be used with the selected trained selected machine learning model 120, to predict the performance (that is, quality metrics) and run-time for each optimization algorithm.

As an example, merged features of the new optimization family (at block 408) can be used with the trained machine learning model to run a performance model 504, using a first optimization algorithm 502, to provide a predicted performance (or quality metric) at 506. Similarly, the merged features (at block 408) are used with the trained machine learning model to run a runtime model 508, using a first optimization algorithm 502, to provide a predicted processing time at 510. In this manner, the selected machine learning model 120 provides the predicted quality and execution time of a first optimization algorithm, as if it were to be applied to the new optimization family.

This process is repeated as the merged features of the new optimization family (at block 408) are used with the trained machine learning model to run a performance model 514, using a second optimization algorithm 512, to provide a predicted performance (or quality metric) at 516. Similarly, the merged features (at block 408) are used with the trained machine learning models to run a runtime model 518, using the second optimization algorithm 512, to provide a predicted processing time at 520. In this manner, the selected machine learning model 120 provides the predicted quality and execution time of a second optimization algorithm, as if it were to be applied to the new optimization family.

This is repeated for all additional optimization algorithms, as illustrated by the three dots. In this manner, the selected machine learning model 120 provides the predicted quality and run-time of each optimization algorithm, as if it were to be applied to the new optimization family.

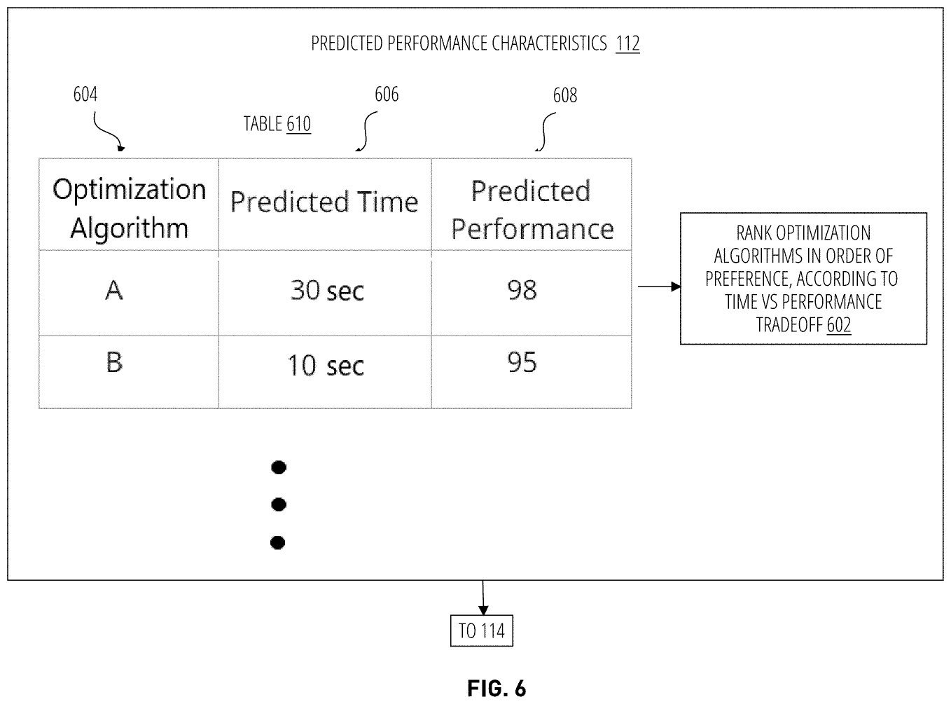

FIG. 6 illustrates a block diagram of the predicted performance characteristics block 112 shown in FIG. 1 in accordance with one embodiment.

Characteristics of each predicted solution are provided in Table 610. The performance characteristics predicted for each optimization algorithm 604 are listed. Here, the two characteristics are predicted: run-time 606 and predicted performance 608 (or quality). As an example of the latter in the field of supply chain management, such metrics can include the timely availability of supplies, the cost of production, the overall revenue, and so on. In some embodiments, each metric can be weighted, with the total weighted sum providing an overall “quality” metric.

From FIG. 6, it is seen that optimization algorithm A results in a predicted run-time of 30 seconds and a quality metric of 98. Optimization algorithm B results in a predicted run-time of 10 seconds and a quality metric of 95. That is, optimization algorithm A takes 3 times longer than optimization algorithm B to execute on the new optimization family. However, the quality of the optimized solution (as measured by a combination of weighted performance metrics) provided by than optimization algorithm A is higher than that of than optimization algorithm B.

A user is thus provided with an idea of which optimization algorithm will provide a solution with the best performance characteristics. In this embodiment, optimization algorithm A provides better overall metrics than optimization algorithm B.

All of the optimization algorithms and their associated predicted characteristics can then be ranked in order of preference, according to priorities of time versus solution quality tradeoff, at block 602.

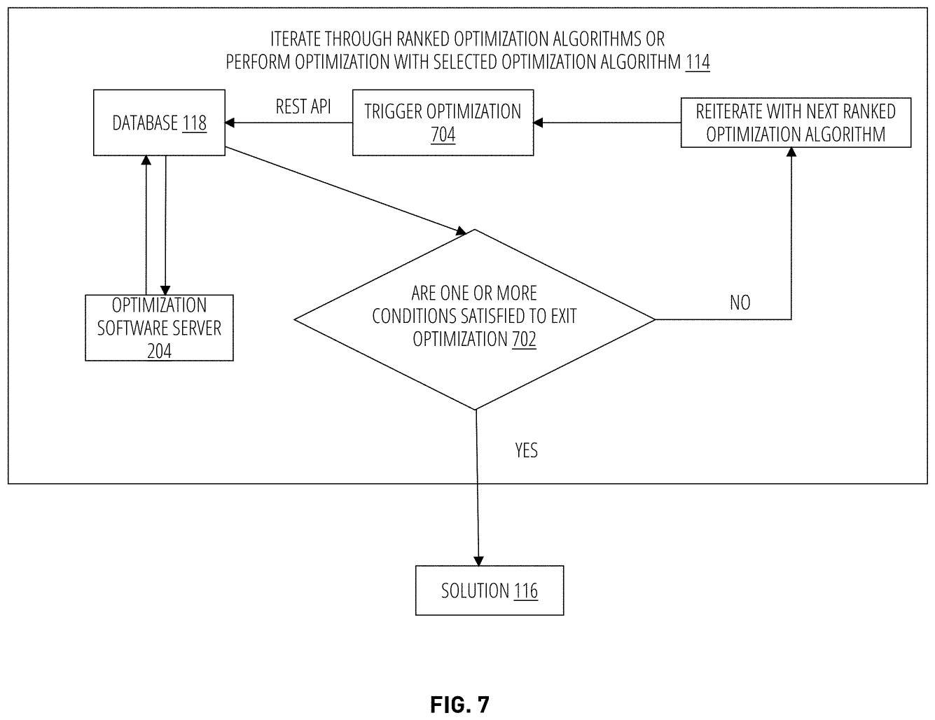

FIG. 7 illustrates a block diagram of the performance optimization block 114 shown in FIG. 1 in accordance with one embodiment.

Once the top-ranked optimization algorithm is selected from Table 610 (in FIG. 6), optimization is triggered at block 704. The database 118 works in tandem with the optimization software server 204 to provide an optimized result of the new optimization family. This result is analyzed at decision block 702. If the executed result meets one or more conditions to exit optimization, then optimization is complete, and a solution is provided at block 116. However, if the conditions are not met, then optimization is triggered using the next-ranked optimization algorithm. The process is then repeated, until a satisfactory solution emerges at block 116. Examples of conditions are discussed below.

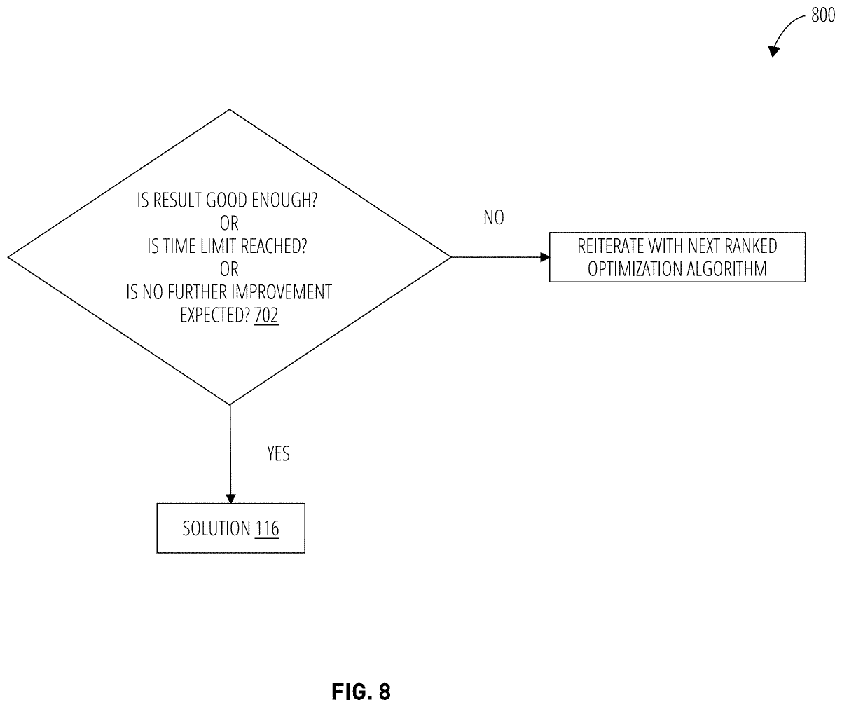

FIG. 8 illustrates of conditions in the decision block 702 shown in FIG. 7 in accordance with one embodiment.

The selected machine learning model produces estimates of optimization algorithm characteristics, as applied to a new optimization family. It is possible that the estimates are quite far away from the actual characteristics, once the selected optimization algorithm is executed on the new optimization family.

One condition in decision block 702 can be to determine if the optimized result (obtained after executing the selected optimization algorithm) is good enough for the user. That is, a user can set an upper limit for the difference between predicted and actual characteristics. If the predicted characteristics are very inaccurate, then the next-ranked optimization algorithm can be executed to see if it's actual characteristics are closer to its expected characteristics, than the previous optimization algorithm. Once the characteristics are acceptable (that is, accurate within a pre-set threshold), then the accompanying optimization solution is accepted.

Another condition in decision block 702 can be to see if a time limit is exceeded for the optimization. As an example, a top-ranked optimization algorithm has a predicted time of execution. However, the actual time of execution may exceed a certain run-time threshold, at which point the execution will be aborted and the next-ranked optimization algorithm is executed, until a solution with an acceptable run-time characteristic is reached.

Another example of setting a run-time limit in decision block 702 is as follows. For example, an upper run-time threshold of 90 seconds per new optimization family can be set. Suppose there are five optimization algorithms, and each is predicted to take 30 seconds to execute on a given problem. Suppose further that the top three-ranked optimization algorithms execute in a total run-time of less than the upper run-time threshold of 90 seconds, yet none yield a result that is good enough (see above). Then, the optimization is aborted (that is, the next-ranked optimization algorithms are not executed). The best solution of the three is then returned as the optimized solution. This is another example of setting a run-time limit in decision block 702.

Another condition in decision block 702 can be to determine if no further improvement is expected. In some embodiments, improvement is a measure of the difference in terms of the quality of a new solution versus that of a previous solution. That is, the machine learning output may suggest the extra time required to compute the next-ranked optimization algorithm is not worth the time and effort, based on a threshold. As an example, the machine learning output of the top-ranked optimization algorithm indicates a run-time of 10 seconds and a quality metric value of ‘X’. The machine learning output of the second-ranked optimization algorithm indicates a run-time of 70 seconds and a quality metric value of ‘0.9X’, suggesting that it is not worthwhile to use the second-ranked optimization algorithm.

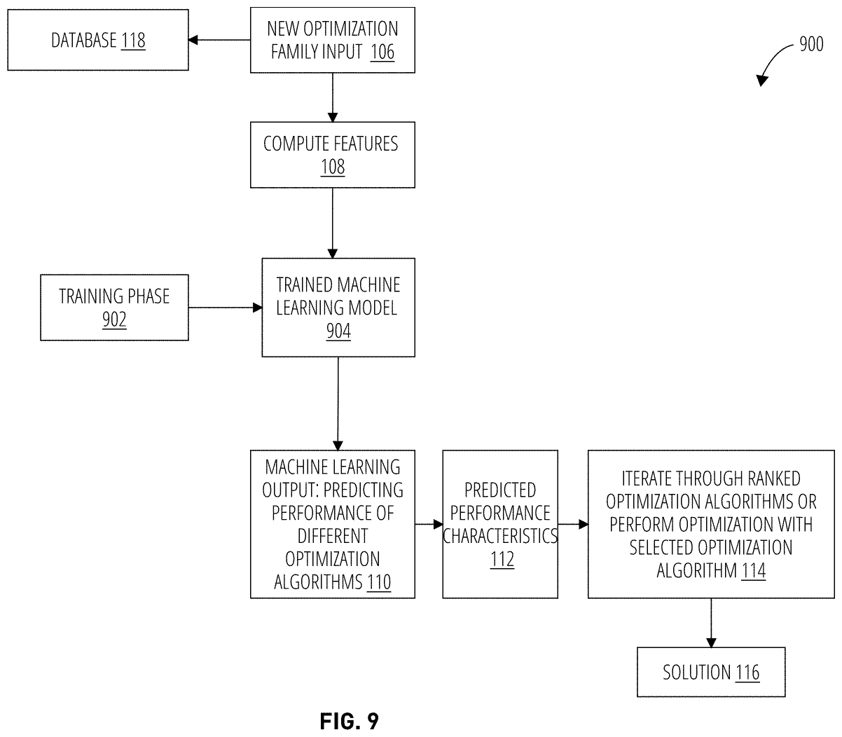

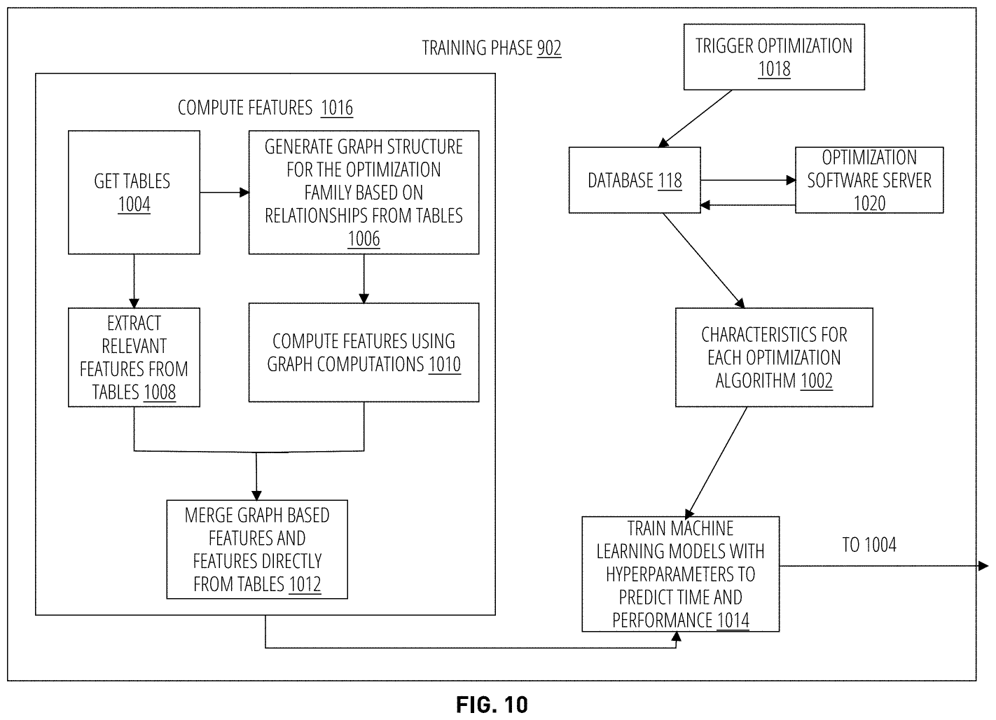

In some embodiments, the step of training, validating and testing a number of machine learning models (box 104 of FIG. 1) can be eliminated by using only one machine learning model in the training phase (102 of FIG. 1). Such an alternative is illustrated in FIG. 9 and FIG. 10.

FIG. 9 illustrates a block diagram 900 in accordance with one embodiment. FIG. 9 is similar to FIG. 1, except that only one machine learning model is trained at training phase 902.

In FIG. 9, a number of optimization families (or optimization problems) have already been solved, in that a number of optimization algorithms have been executed on each optimization family to find an optimal solution for each optimization family. The optimization algorithms may be versions of mixed-integer linear optimization.

For a given optimization family, each optimization algorithm takes a certain amount of run-time to execute. Furthermore, each optimization algorithm provides an optimized solution whose quality is measured by a corresponding quality metric. All of this information is stored in database 118. The term “optimization family” is used to include instances where it is not just one particular problem that is being optimized, but an entire family of related problems that is being optimized. As an example, with reference to supply chain management, an optimization family refers to a whole family of inter-dependent parts (in a supply chain) that have one or more relationships between each other.

In FIG. 9, a new optimization family (or “new problem”), shown at 106, is to be optimized. However, instead of executing each optimization algorithm on the new problem in order to find out which optimization algorithm provides the optimum solution, block diagram 900 illustrates the use of machine learning to predict how long each optimization algorithm will take to optimize the new problem, along with predicting the corresponding quality metric of each optimization algorithm. This approach greatly improves computer efficiency, CPU time and data storage.

For example, computer efficiency is enhanced, in that the disclosed systems and methods provide more in less time: namely one optimization algorithm is applied to an optimization problem in order to arrive at the best solution possible (in terms of a combination of run-time and quality metric), instead of applying all available algorithms to the given problem. Furthermore, since the “CPU time” is the total time that computer spends to optimize a problem by an optimization algorithm, the disclosed systems and methods decrease CPU time since not all of the optimization algorithms are executed on the problem at hand. Finally, there is improvement in data storage, since one optimization algorithm is selected to apply on a given optimization problem, thereby reducing the number of optimized solutions kept in storage. keep in the storage will decrease.

Data associated with the new optimization family (item 106) can be stored in database 118. As an example, with reference to supply chain management, such data can include the lead time of a part, which sites are manufacturing this part, what are the components assembled for this part, and so on. Furthermore, the new optimization family input may be used to compute features of the new optimization family at 108. These features can be used in conjunction with a trained machine learning model to predict characteristics of each optimization algorithm (namely, predicted run-time and solution quality), as if it had been executed on the new optimization family.

The features computed at 108 can use the optimization family input (item 106) as input and data from the database 118. The optimization family input (item 106) may also be stored in the database 118, for possible later use in further training of machine learning models.

A training phase 902 can provide a trained machine learning model at Trained machine learning model 904. As an example, the machine learning model trained at training phase 902 can be any type of machine learning model. Non-limiting examples of machine learning models include decision trees, neural networks and support vector machines. In some embodiments, a tree-based machine learning model is used.

The machine learning model can be trained using hyperparameter optimization. Optimal hyperparameter values can be found by making use of different samples such as Bayesian, random, evolutionary and grid search algorithms.

At 110, the trained machine learning model can predict the performance of each of the optimization algorithms, using the features that have been computed at 108.

Once the performance of each of the optimization algorithms is predicted via machine learning at block 110, the predicted performance characteristics are listed at 112, and may be ranked according to a pre-determined criteria. In some embodiments, the performance characteristics can include the run-time for executing the a given optimization algorithm, and metrics associated with one or more goals of the final optimization. As an example of the latter in the field of supply chain management, such metrics can include the timely availability of supplies, the cost of production, the overall revenue, and so on. In some embodiments, each metric can be weighted, with the total weighted sum providing an overall “quality” metric.

The top-ranked optimization algorithm can then be selected, and executed to perform the optimization on the optimization family at block 114, thereby providing an optimized solution at block 116. Alternatively, there can be an iteration of the ranked optimization algorithms until a reasonable solution is found.

The actual solution is then stored in the database 118, along with the characteristics associated with the selected optimization algorithm, for use in further machine learning training. In this manner, computer efficiency is increased, CPU time is decreased, and database storage is decreased by running only one optimization algorithm on the new optimization family.

FIG. 10 illustrates a block diagram of the training phase 902 shown in FIG. 9, in accordance with one embodiment. FIG. 10 is similar to FIG. 2, except at box 1014, in which only one machine learning model is trained.

Features of each previous optimization families are computed at block 1016. In some embodiments, features can be computed from basic input tabular data, and graphs (or tree structures) that are generated from the tabular input. Generation of graphical relationships from tabular data can provide additional knowledge of the structural relationship between various entities, thereby enhancing the robustness of the machine learning training. For example, in supply chain management of bicycles, table records provide useful data such as the names of the manufacturing sites, the amount of labor available per day at a production line, and so on, while graphs can be generated based on information in the tables, such as the relationship between the various components needed to manufacture a bicycle.

Basic input used to calculate features can include tables, at block 1004. As an example, in the field of supply chain management, these tables can include a table of Bill of Materials, and other supply chain features. Relevant features may be extracted from the tables at block 1008.

The tables (at block 1004) can also be used to generate, at block 1006, a graph structure for an optimization family based on relationships between entities in the tables. Data may be naturally understood as a network/graph and the relationships between the various data points matter for the problem at hand. For example, in the supply chain management of bicycles, one component of a bicycle is a wheel, which in turn requires an ‘X’ number of bearings. A graph of the data reveals that the bicycle requires an ‘X’ number of bearings. Furthermore, the relationships between the various data points can be illustrated through a graph. For example, a bicycle with three layers of dependent materials is easier to plan for than a bicycle with seven layers. An example of a graph structure is shown in FIG. 3. Features of the graph structure are then computed using graph computations at block 1010.

At block 1012, the features extracted from the tables (at block 1008) may be merged with the features computed at block 1010.

At block 202, optimization can be triggered for the optimization family for which the features are being computed. This optimization results in a database 118 working in tandem with an optimization software server 204 to execute each optimization algorithm on the optimization family. In addition to providing the solution to the optimization problem, each optimization algorithm can also provide a set of characteristics associated with its execution. For example, characteristics can include the execution time of the optimization algorithm (on the given optimization family), along with different metrics that measure the quality of the optimized solution. As an example of the latter in the field of supply chain management, such metrics can include the timely availability of supplies, the cost of production, the overall revenue, and so on. In some embodiments, each metric can be weighted, with the total weighted sum providing an overall “quality” metric.

The characteristics from block 1002 can be used with the merged features from block 1012, to train machine learning model at block 1014 in order to predict the characteristics of the optimization algorithms for new optimization families. In simple terms, the input for the training can include features of each optimization family and a feature that identifies a particular optimization algorithm (for example, an optimization algorithm identification number). The output can include the corresponding optimization algorithm characteristics.

The machine learning model can belong to a common class, or type, of model. As an example, a machine learning model from a gradient boosting library can be used, such as LGBM. As a further example, the machine learning model trained at training phase 902 can be a tree-based machine learning model. Other types of models are also possible, such as neural networks and support vector machines. The machine learning model can be trained using hyperparameter optimization. Optimal hyperparameter values can be found by making use of different samples such as Bayesian, random, evolutionary and grid search algorithms.

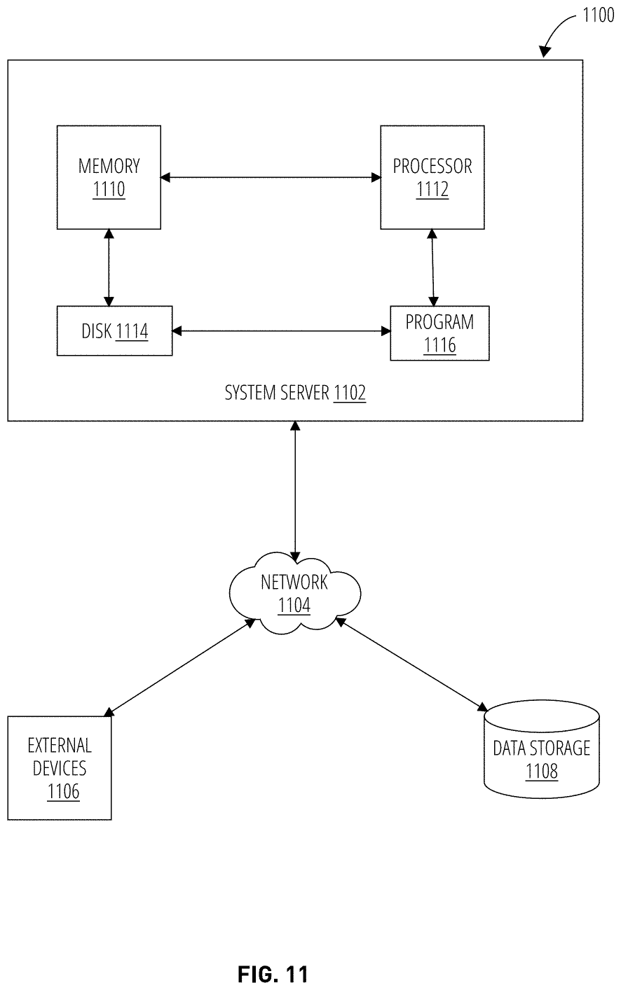

FIG. 11 illustrates a computer system 1100 in accordance with one embodiment.

One or more embodiments of the invention, or elements thereof, can be implemented in the form of an system including a memory and at least one processor that is coupled to the memory and operative to perform exemplary method steps.

System server 1102 may be described in the general context of computer system executable instructions, such as program modules, being executed by a computer system. Generally, program modules may include routines, programs, objects, components, logic, data structures, and so on that perform particular tasks or implement particular abstract data types. system server 1102 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, system server 1102 is shown in the form of a general-purpose computing device. The components of system server 1102 may include, but are not limited to, one or more processors 1112, a memory 1110, program 1116 and disk 1114 may be coupled by a bus structure (not shown).

Program 1116 may comprise a set of program modules which can execute functions and/or methods of embodiments of the invention as described herein.

Computer system 1100 can also include additional features and/or functionality. For example, computer system 1100 can also include additional storage (removable and/or non-removable) including, but not limited to, magnetic or optical disks or tape. Such additional storage is illustrated in FIG. 11 by memory 1110 and disk 1114. Storage media can include volatile and nonvolatile, removable and non-removable media implemented in any method or technology for storage of information such as computer-readable instructions, data structures, program modules or other data. Memory 1110 and disk 1114 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by computer system 1100. Any such non-transitory computer-readable storage media can be part of computer system 1100.

Communication between system server 1102, external devices 1106 and data storage 1108 via network 1104 can be over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). Generally, communication between various components of system 200 may take place over hard-wired, cellular, Wi-Fi or Bluetooth networked components or the like. In some embodiments, one or more electronic devices of system 200 may include cloud-based features, such as cloud-based memory storage. It should be understood that although not shown, other hardware and/or software components could be used in conjunction with system server 1102.

While data storage 1108 is illustrated as separate from system server 1102, data storage 1108 can also be integrated into system server 1102, either as a separate component within system server 1102, or as part of at least one of memory 1110 and disk 1114.

Data storage 1108 may implement an “in-memory” database, in which volatile (e.g., non-disk-based) storage (e.g., Random Access Memory) is used both for cache memory and for storing the full database during operation, and persistent storage (e.g., one or more fixed disks) is used for offline persistency and maintenance of database snapshots. Alternatively, volatile storage may be used as cache memory for storing recently-used data, while persistent storage stores the full database.

Data storage 1108 may store metadata regarding the structure, relationships and meaning of data. This information may include data defining the schema of database tables stored within the data. A database table schema may specify the name of the database table, columns of the database table, the data type associated with each column, and other information associated with the database table. Data storage 1108 may also or alternatively support multi-tenancy by providing multiple logical database systems which are programmatically isolated from one another. Moreover, the data may be indexed and/or selectively replicated in an index to allow fast searching and retrieval thereof.

System server 1102 may also communicate with one or more external devices 1106 such as a keyboard, a pointing device, a display, etc.; one or more devices that enable a user to interact with system server 1102; and/or any devices that enable system server 1102 to communicate with one or more other computing devices.

Thus, one or more embodiments can make use of software running on a general purpose computer or workstation. With reference to FIG. 11, such an implementation might employ, for example, a processor 1112, a memory 1110, and one or more external devices 1106 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device, a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer).

Accordingly, computer software including instructions or code for performing methods as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 1112 coupled directly or indirectly to memory 1110. The memory elements can include local memory employed during actual implementation of the program code, bulk storage, and cache memories which provide temporary storage of at least some program code in order to reduce the number of times code must be retrieved from bulk storage during implementation.

As used herein, including the claims, a “server” includes a physical data processing system (for example, system server 1102 as shown in FIG. 11) running a server program. It will be understood that such a physical server may or may not include a display and keyboard.

One or more embodiments can be at least partially implemented in the context of a cloud or virtual machine environment, although this is exemplary and non-limiting.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 1112. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

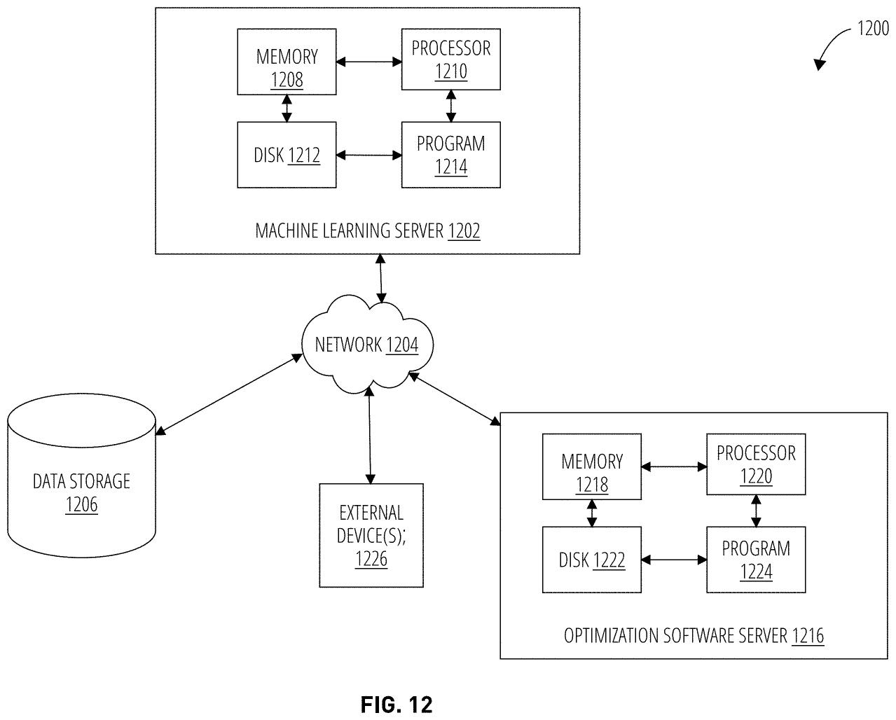

FIG. 12 illustrates a system 1200 in accordance with one embodiment. Basic hardware includes a data storage 1206 in communication with a machine learning server 1202 and an optimization software server 1216 via network 1204.

As in FIG. 11, each server can independently include, but is not limited to, one or more processors, a memory, a program and a disk, each of which may be coupled by a bus structure.

As shown in FIG. 12, machine learning server 1202 may include, but is not limited to, one or more processors 1210, a memory 1208, program 1214 and disk 1212 that may be coupled by a bus structure (not shown). Program 1214 may comprise a set of program modules which can execute functions and/or methods of embodiments of the invention as described herein.

Similarly, optimization software server 1216 may include, but is not limited to, one or more processors 1220, a memory 1218, program 1224 and disk disks 1222 that may be coupled by a bus structure (not shown). Program 1224 may comprise a set of program modules which can execute functions and/or methods of embodiments of the invention as described herein.

System 1200 can also include additional features and/or functionality. For example, system 1200 can also include additional storage (removable and/or non-removable) including, but not limited to, magnetic or optical disks or tape. Such additional storage is illustrated in FIG. 12, in machine learning server 1202, by memory 1208 and disk 1212; and in optimization software server 1216 by memory 1218 and disk 1222. Storage media can include volatile and nonvolatile, removable and non-removable media implemented in any method or technology for storage of information such as computer-readable instructions, data structures, program modules or other data. Memory 1110. memory 1218, disk 1222 and disk 1114 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 1200. Any such non-transitory computer-readable storage media can be part of system 1200.

Communication between machine learning server 1202, optimization software server 1216 and data storage 1206 via network 1204 can be over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). Generally, communication between various components of system 200 may take place over hard-wired, cellular, Wi-Fi or Bluetooth networked components or the like. In some embodiments, one or more electronic devices of system 200 may include cloud-based features, such as cloud-based memory storage. It should be understood that although not shown, other hardware and/or software components could be used in conjunction with machine learning server 1202 and 1216, respectively.

While data storage 1206 is illustrated as separate from either machine learning server 1202 and optimization software server 1216, data storage 1206 can also be integrated into machine learning server 1202 and/or optimization software server 1216, either as a separate component within each of machine learning server 1202 and/or optimization software server 1216, or as part of at least one of memory and disk in each server.

Data storage 1206 may implement an “in-memory” database, in which volatile (e.g., non-disk-based) storage (e.g., Random Access Memory) is used both for cache memory and for storing the full database during operation, and persistent storage (e.g., one or more fixed disks) is used for offline persistency and maintenance of database snapshots. Alternatively, volatile storage may be used as cache memory for storing recently-used data, while persistent storage stores the full database.

Data storage 1206 may store metadata regarding the structure, relationships and meaning of data. This information may include data defining the schema of database tables stored within the data. A database table schema may specify the name of the database table, columns of the database table, the data type associated with each column, and other information associated with the database table. Data storage 1206 may also or alternatively support multi-tenancy by providing multiple logical database systems which are programmatically isolated from one another. Moreover, the data may be indexed and/or selectively replicated in an index to allow fast searching and retrieval thereof.

Each server may also communicate with one or more external device(s); 1226 such as a keyboard, a pointing device, a display, etc.; one or more devices that enable a user to interact respectively with machine learning server 1202 and optimization software server 1216; and/or any devices that enable either machine learning server 1202 or optimization software server 1216 to communicate with one or more other computing devices.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
extracting, by a processor, a first set of features from a plurality of optimization problems;
receiving, by the processor, respective characteristics of a plurality of optimization algorithms, the characteristics of each algorithm based on application of the optimization algorithm applied to each optimization problem of the plurality of optimization problems;
training, by the processor, a plurality of machine learning models on a first portion of a dataset, the dataset comprising the first set of features and the respective characteristics;
selecting a trained machine learning model based on a second portion of the dataset;
extracting, by the processor, a second set of features related to a new optimization problem; and
obtaining, by the processor, predicted performance characteristics for each optimization algorithm based on application of the selected trained machine learning model on the second set of features.

2. The computer-implemented method of claim 1, wherein the performance characteristics comprise a run-time and a performance metric.

3. The computer-implemented method of claim 1, wherein:
each of the first set of features and the second set of features is based on tabular data and graph structures generated from the tabular data.

4. The computer-implemented method of claim 1, further comprising:
ranking, by the processor, each optimization algorithm according to the predicted performance characteristics.

5. The computer-implemented method of claim 4, further comprising:
executing, by the processor, a first-ranked optimization algorithm on the new optimization problem.

6. The computer-implemented method of claim 4, further comprising:
iterating, by the processor, through successively-ranked optimization algorithms until one or more conditions are satisfied.

7. The computer-implemented method of claim 6, wherein the one or more conditions are:
an actual run-time and an actual performance metric that is acceptable; or
attain a run-time limit; or
expectation of no further improvement on the run-time and performance metric of the successively-ranked optimization algorithms.

8. A system comprising:
a processor; and
a memory storing instructions that, when executed by the processor, configure the system to:
extract, by the processor, a first set of features from a plurality of optimization problems;
receive, by the processor, respective characteristics of a plurality of optimization algorithms, the characteristics of each algorithm based on application of the optimization algorithm applied to each optimization problem of the plurality of optimization problems;
train, by the processor, a plurality of machine learning models on a first portion of a dataset, the dataset comprising the first set of features and the respective characteristics;
select a trained machine learning model based on a second portion of the dataset;
extract, by the processor, a second set of features related to a new optimization problem; and
obtain, by the processor, predicted performance characteristics for each optimization algorithm based on application of the selected trained machine learning model on the second set of features.

9. The system of claim 8, wherein:
each of the first set of features and the second set of features is based on tabular data and graph structures generated from the tabular data.

10. The system of claim 8, wherein the performance characteristics comprise a run-time and a performance metric.

11. The system of claim 8, wherein the instructions further configure the system to:
rank, by the processor, each optimization algorithm according to the predicted performance characteristics.

12. The system of claim 11, wherein the instructions further configure the system to:
execute, by the processor, a first-ranked optimization algorithm on the new optimization problem.

13. The system of claim 11, wherein the instructions further configure the system to:
iterate, by the processor, through successively-ranked optimization algorithms until one or more conditions are satisfied.

14. The system of claim 13, wherein the one or more conditions are:
an actual run-time and an actual performance metric that is acceptable; or
attain a run-time limit; or
expectation of no further improvement on the run-time and performance metric of the successively-ranked optimization algorithms.

15. A non-transitory computer-readable storage medium, the computer-readable storage medium including instructions that when executed by a computer, cause the computer to:
extract, by a processor, a first set of features from a plurality of optimization problems;
receive, by the processor, respective characteristics of a plurality of optimization algorithms, the characteristics of each algorithm based on application of the optimization algorithm applied to each optimization problem of the plurality of optimization problems;
train, by the processor, a plurality of machine learning models on a first portion of a dataset, the dataset comprising the first set of features and the respective characteristics;
select a trained machine learning model based on a second portion of the dataset;
extract, by the processor, a second set of features related to a new optimization problem; and
obtain, by the processor, predicted performance characteristics for each optimization algorithm based on application of the selected trained machine learning model on the second set of features.

16. The computer-readable storage medium of claim 15, wherein the performance characteristics comprise a run-time and a performance metric.

17. The computer-readable storage medium of claim 15, wherein:
each of the first set of features and the second set of features is based on tabular data and graph structures generated from the tabular data.

18. The computer-readable storage medium of claim 15, wherein the instructions further configure the computer to:
rank, by the processor, each optimization algorithm according to the predicted performance characteristics.

19. The computer-readable storage medium of claim 18, wherein the instructions further configure the computer to:
execute, by the processor, a first-ranked optimization algorithm on the new optimization problem.

20. The computer-readable storage medium of claim 18, wherein the instructions further configure the computer to:
iterate, by the processor, through successively-ranked optimization algorithms until one or more conditions are satisfied.

21. The computer-readable storage medium of claim 20, wherein the one or more conditions are:
an actual run-time and an actual performance metric that is acceptable; or
attain a run-time limit; or
expectation of no further improvement on the run-time and performance metric of the successively-ranked optimization algorithms.
